(19) United States
(12) Patent Application Publication
(10) Pub. No.: US 2024/0286609 A1
(43) Pub. Date: Aug. 29, 2024

(54) ANIMAL COLLISION AWARE PLANNING SYSTEMS AND METHODS FOR AUTONOMOUS VEHICLES

(71) Applicant: TORC Robotics, Inc., Blacksburg, VA (US)

(72) Inventors: Adam SHOEMAKER, Blacksburg, VA (US); Christopher HARRISON, Blacksburg, VA (US)

(73) Assignee: TORC Robotics, Inc., Blacksburg, VA (US)

(21) Appl. No.: 18/302,520

(22) Filed: Apr. 18, 2023

Related U.S. Application Data
(60) Provisional application No. 63/447,768, filed on Feb. 23, 2023.

(51) Int. Cl. B60W 30/095; B60Q 9/00; B60W 60/00

(52) U.S. Cl. CPC B60W 30/0956; B60Q 9/008; B60W 60/0011; B60W 2554/404

(57) ABSTRACT

Disclosed herein are methods and systems to avoid collisions with animals. In an example, a method comprises receiving, by a processor, an indication that a current trajectory of an autonomous vehicle is associated with a likelihood of a collision that satisfies a collision threshold indicating a potential collision with an animal having an attribute that satisfies a threshold; disabling, by the processor, at least one lighting apparatus associated with the autonomous vehicle; and enabling, by the processor, a sound-generating device associated with the autonomous vehicle.

### CROSS-REFERENCE TO RELATED APPLICATIONS

This application claims priority to U.S. Provisional Patent Application No. 63/447,768, filed Feb. 23, 2023, which is incorporated by reference in its entirety.

### TECHNICAL FIELD

The present disclosure relates generally to autonomous vehicles and, more specifically, to systems and methods for autonomous vehicle operation.

### BACKGROUND

The use of autonomous vehicles has become increasingly prevalent in recent years, with the potential for numerous benefits, such as improved safety, reduced traffic congestion, and increased mobility for people with disabilities. However, with the deployment of autonomous vehicles on public roads, there is a growing concern about the potential for collisions with wildlife, which can cause harm to both animals and humans.

Animals, such as deer, elk, and wild pigs, can be unpredictable and may not understand or react to the presence of autonomous vehicles in the same way they would with human-operated vehicles. In addition, autonomous vehicles may be equipped with sensors and cameras that are able to detect certain animals better than a human driver, particularly those that are small or camouflage well with their surroundings. Moreover, many areas where autonomous vehicles are likely to be deployed, such as rural and suburban regions, are also home to large populations of wild animals. This increases the likelihood of interactions between autonomous vehicles and wildlife, and can result in collisions that cause injury or death to the animals, extensive damage to the autonomous vehicle, or, in the worst case, pose a significant risk to other human-operated vehicles nearby.

### SUMMARY

The systems and methods of the present disclosure may solve the problems set forth above and/or other problems in the art. The scope of the current disclosure, however, is defined by the attached claims, and not by the ability to solve any specific problem. Disclosed herein are methods and systems for optimizing path planning and autonomous vehicle operation when facing animals on the road. When driving at night, for example, shining lights toward the animal may not have the intended effect of causing the animal to move, but turning off the lights and honking a horn may be more effective. Various processes may be executed to urge the animal to move before the autonomous vehicle changes trajectory, slows down, or even stops.

In an embodiment, a method comprises receiving, by a processor, an indication that a current trajectory of an autonomous vehicle is associated with a likelihood of a collision that satisfies a collision threshold indicating a potential collision with an animal having an attribute that satisfies a threshold; disabling, by the processor, at least one lighting apparatus associated with the autonomous vehicle; and enabling, by the processor, a sound-generating device associated with the autonomous vehicle and/or enabling an alternative light emitting device that does not limit the perceptive abilities of the animal (e.g. using a light with a different color or intensity).

In another embodiment, a system comprises a computer readable medium having a set of instructions, that when executed, cause a processor to receive an indication that a current trajectory of an autonomous vehicle is associated with a likelihood of a collision that satisfies a collision threshold indicating a potential collision with an animal having an attribute that satisfies a threshold; disable at least one lighting apparatus associated with the autonomous vehicle; and enable a sound-generating device associated with the autonomous vehicle and/or enabling an alternative light emitting device that does not limit the perceptive abilities of the animal (e.g. using a light with a different color or intensity).

In another embodiment, an autonomous vehicle comprises a processor configured to receive an indication that a current trajectory of an autonomous vehicle is associated with a likelihood of a collision that satisfies a collision threshold indicating a potential collision with an animal having an attribute that satisfies a threshold; disable at least one lighting apparatus associated with the autonomous vehicle; and enable a sound-generating device associated with the autonomous vehicle and/or enabling an alternative light emitting device that does not limit the perceptive abilities of the animal (e.g. using a light with a different color or intensity).

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a bird's eye view of a roadway including a schematic representation of a vehicle and aspects of an autonomy system of the vehicle, according to an embodiment.

FIG. 2 is a schematic of the autonomy system of the vehicle, according to an embodiment.

FIG. 3 is a schematic diagram of a collision analysis module of the autonomy system of the vehicle, according to an embodiment.

FIG. 4 is a method of navigating of an autonomous vehicle, according to an embodiment

FIG. 5 is a bird's eye view of a roadway scenario including a schematic representative of an autonomous vehicle and various target objects in a region of collision proximity to the autonomous vehicle, according to an embodiment.

### DETAILED DESCRIPTION

The following detailed description describes various features and functions of the disclosed systems and methods with reference to the accompanying figures. In the figures, similar components are identified using similar symbols, unless otherwise contextually dictated. The exemplary system(s) and method(s) described herein are not limiting and it may be readily understood that certain aspects of the disclosed systems and methods can be variously arranged and combined, all of which arrangements and combinations are contemplated by this disclosure.

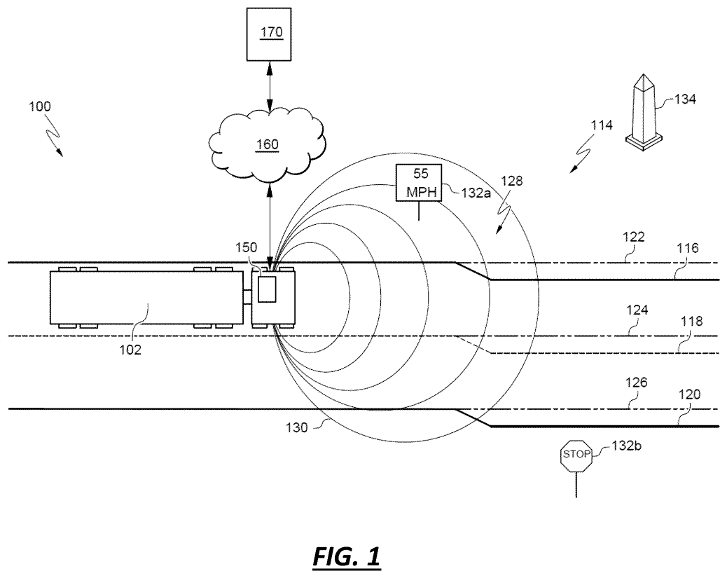

Referring to FIG. 1, the present disclosure relates to autonomous vehicles, such as an autonomous truck 102 having an autonomy system 150. The autonomy system 150 of truck 102 may be completely autonomous (fully-autonomous), such as self-driving, driverless, or Level 4 autonomy, or semi-autonomous, such as Level 3 autonomy. As used herein the term “autonomous” includes both fully-autonomous and semi-autonomous. The present disclosure sometimes refers to autonomous vehicles as ego vehicles. The autonomy system 150 may be structured on at least three aspects of technology: (1) perception, (2) maps/localization, and (3) behaviors planning and control. The function of the perception aspect is to sense an environment surrounding truck 102 and interpret it. To interpret the surrounding environment, a perception module or engine in the autonomy system 150 of the truck 102 may identify and classify objects or groups of objects in the environment. For example, a perception module associated with various sensors (e.g., LiDAR, camera, radar, etc.) of the autonomy system 150 may identify one or more objects (e.g., pedestrians, vehicles, debris, etc.) and features of the roadway (e.g., lane lines) around truck 102, and classify the objects in the road distinctly.

The maps/localization aspect of the autonomy system 150 may be configured to determine where on a pre-established digital map the truck 102 is currently located. One way to do this is to sense the environment surrounding the truck 102 (e.g., via the perception system) and to correlate features of the sensed environment with details (e.g., digital representations of the features of the sensed environment) on the digital map.

Once the systems on the truck 102 have determined its location with respect to the digital map features (e.g., location on the roadway, upcoming intersections, road signs, etc.), the truck 102 can plan and execute maneuvers and/or routes with respect to the features of the digital map. The behaviors, planning, and control aspects of the autonomy system 150 may be configured to make decisions about how the truck 102 should move through the environment to get to its goal or destination. It may consume information from the perception and maps/localization modules to know where it is relative to the surrounding environment and what other objects and traffic actors are doing.

FIG. 1 further illustrates an environment 100 for modifying one or more actions of truck 102 using the autonomy system 150. The truck 102 is capable of communicatively coupling to a remote server 170 via a network 160. The truck 102 may not necessarily connect with the network 160 or server 170 while it is in operation (e.g., driving down the roadway). That is, the server 170 may be remote from the vehicle, and the truck 102 may deploy with all the necessary perception, localization, and vehicle control software and data necessary to complete its mission fully-autonomously or semi-autonomously.

While this disclosure refers to a truck (e.g., a tractor trailer) 102 as the autonomous vehicle, it is understood that the truck 102 could be any type of vehicle including an automobile, a mobile industrial machine, etc. While the disclosure will discuss a self-driving or driverless autonomous system, it is understood that the autonomous system could alternatively be semi-autonomous having varying degrees of autonomy or autonomous functionality.

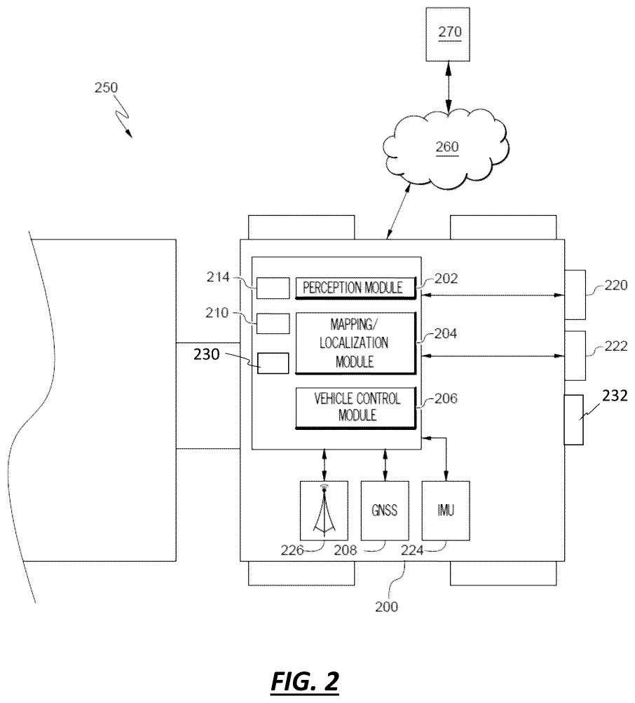

With reference to FIG. 2, an autonomy system 250 may include a perception system including a camera system 220, a LiDAR system 222, a radar system 232, a thermal imaging system (not shown), an ultrasonic sensing system (not shown), an auditory sensing system (not shown), a GNSS receiver 208, an inertial measurement unit (IMU) 224, and/or a perception module 202. The autonomy system 250 may further include a transceiver 226, a processor 210, a memory 214, a mapping/localization module 204, and a vehicle control module 206. The various systems may serve as inputs to and receive outputs from various other components of the autonomy system 250. In other examples, the autonomy system 250 may include more, fewer, or different components or systems, and each of the components or system(s) may include more, fewer, or different components. Additionally, the systems and components shown may be combined or divided in various ways. As show in FIG. 1, the perception systems aboard the autonomous vehicle may help the truck 102 perceive its environment out to a perception radius 130. The actions of the truck 102 may depend on the extent of perception radius 130.

The camera system 220 of the perception system may include one or more cameras mounted at any location on the truck 102, which may be configured to capture images of the environment surrounding the truck 102 in any aspect or field of view (FOV). The FOV can have any angle or aspect such that images of the areas ahead of, to the side, and behind the truck 102 may be captured. In some embodiments, the FOV may be limited to particular areas around the truck 102 (e.g., forward of the truck 102) or may surround 360 degrees of the truck 102. In some embodiments, the image data generated by the camera system(s) 220 may be sent to the perception module 202 and stored, for example, in memory 214.

The LiDAR system 222 may include a laser generator and a detector and can send and receive a LiDAR signals. The LiDAR signal can be emitted to and received from any direction such that LiDAR point clouds (or “LiDAR images”) of the areas ahead of, to the side, and behind the truck 200 can be captured and stored as LiDAR point clouds. In some embodiments, the truck 200 may include multiple LiDAR systems and point cloud data from the multiple systems may be stitched together. In some embodiments, the system inputs from the camera system 220 and the LiDAR system 222 may be fused (e.g., in the perception module 202). The LiDAR system 222 may include one or more actuators to modify a position and/or orientation of the LiDAR system 222 or components thereof. The LIDAR system 222 may be configured to use ultraviolet (UV), visible, or infrared light to image objects and can be used with a wide range of targets. In some embodiments, the LiDAR system 222 can be used to map physical features of an object with high resolution (e.g., using a narrow laser beam). In some examples, the LiDAR system 222 may generate a point cloud and the point cloud may be rendered to visualize the environment surrounding the truck 200 (or object(s) therein). In some embodiments, the point cloud may be rendered as one or more polygon(s) or mesh model(s) through, for example, surface reconstruction. Collectively, the LiDAR system 222 and the camera system 220 may be referred to herein as “imaging systems.”

The radar system 232 may estimate strength or effective mass of an object, as objects made out of paper or plastic may be weakly detected. The radar system 232 may be based on 24 GHZ, 77 GHZ, or other frequency radio waves. The radar system 232 may include short-range radar (SRR), mid-range radar (MRR), or long-range radar (LRR). One or more sensors may emit radio waves, and a processor processes received reflected data (e.g., raw radar sensor data).

The GNSS receiver 208 may be positioned on the truck 200 and may be configured to determine a location of the truck 200 via GNSS data, as described herein. The GNSS receiver 208 may be configured to receive one or more signals from a global navigation satellite system (GNSS) (e.g., GPS system) to localize the truck 200 via geolocation. The GNSS receiver 208 may provide an input to and otherwise communicate with mapping/localization module 204 to, for example, provide location data for use with one or more digital maps, such as an HD map (e.g., in a vector layer, in a raster layer or other semantic map, etc.). In some embodiments, the GNSS receiver 208 may be configured to receive updates from an external network.

The IMU 224 may be an electronic device that measures and reports one or more features regarding the motion of the truck 200. For example, the IMU 224 may measure a velocity, acceleration, angular rate, and or an orientation of the truck 200 or one or more of its individual components using a combination of accelerometers, gyroscopes, and/or magnetometers. The IMU 224 may detect linear acceleration using one or more accelerometers and rotational rate using one or more gyroscopes. In some embodiments, the IMU 224 may be communicatively coupled to the GNSS receiver 208 and/or the mapping/localization module 204, to help determine a real-time location of the truck 200, and predict a location of the truck 200 even when the GNSS receiver 208 cannot receive satellite signals.

The transceiver 226 may be configured to communicate with one or more external networks 260 via, for example, a wired and/or wireless connection in order to send and receive information (e.g., to a remote server 270). The wireless connection may be a wireless communication signal (e.g., Wi-Fi, cellular, LTE, 5g, etc.) In some embodiments, the transceiver 226 may be configured to communicate with external network(s) via a wired connection, such as, for example, during initial installation, testing, or service of the autonomy system 250 of the truck 200. A wired/wireless connection may be used to download and install various lines of code in the form of digital files (e.g., HD digital maps), executable programs (e.g., navigation programs), and other computer-readable code that may be used by the system 250 to navigate the truck 200 or otherwise operate the truck 200, either fully-autonomously or semi-autonomously. The digital files, executable programs, and other computer readable code may be stored locally or remotely and may be routinely updated (e.g., automatically or manually) via the transceiver 226 or updated on demand. In some embodiments, the truck 200 may not be in constant communication with the network 260 and updates which would otherwise be sent from the network 260 to the truck 200 may be stored at the network 260 until such time as the network connection is restored. In some embodiments, the truck 200 may deploy with all of the data and software it needs to complete a mission (e.g., necessary perception, localization, and mission planning data) and may not utilize any connection to network 260 during some or the entire mission. Additionally, the truck 200 may send updates to the network 260 (e.g., regarding unknown or newly detected features in the environment as detected by perception systems) using the transceiver 226. For example, when the truck 200 detects differences in the perceived environment with the features on a digital map, the truck 200 may update the network 260 with information, as described in greater detail herein.

The processor 210 of autonomy system 250 may be embodied as one or more of a data processor, a microcontroller, a microprocessor, a digital signal processor, a logic circuit, a programmable logic array, or one or more other devices for controlling the autonomy system 250 in response to one or more of the system inputs. Autonomy system 250 may include a single microprocessor or multiple microprocessors that may include means for identifying and reacting to differences between features in the perceived environment and features of the maps stored on the truck 260. Numerous commercially available microprocessors can be configured to perform the functions of the autonomy system 250. It should be appreciated that autonomy system 250 could include a general machine controller capable of controlling numerous other machine functions. Alternatively, a special-purpose machine controller could be provided. Further, the autonomy system 250, or portions thereof, may be located remote from the system 250. For example, one or more features of the mapping/localization module 204 could be located remote of truck 260. Various other known circuits may be associated with the autonomy system 250, including signal-conditioning circuitry, communication circuitry, actuation circuitry, and other appropriate circuitry.

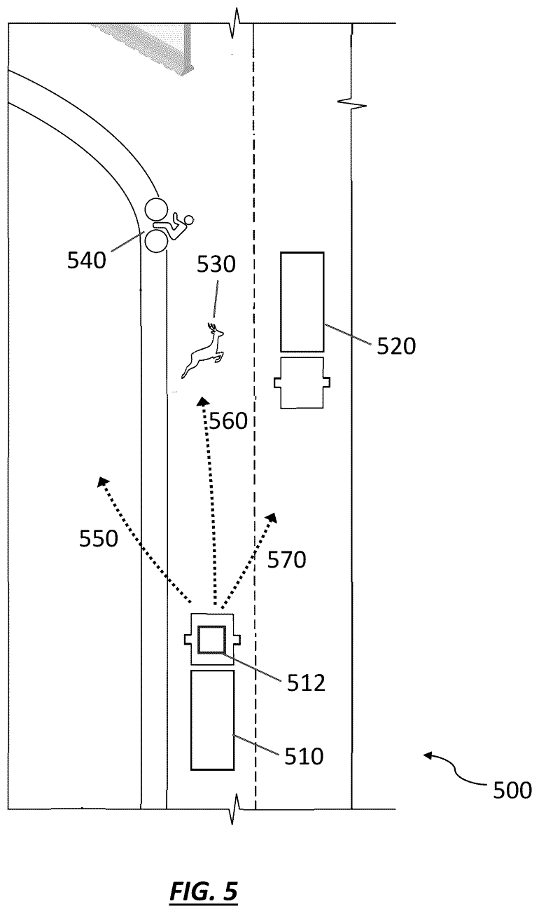

The memory 214 of autonomy system 250 may store data and/or software routines that may assist the autonomy system 250 in performing its functions, such as the functions of the perception module 202, the mapping/localization module 204, the vehicle control module 206, a collision analysis module 230, the method 500 described herein with respect to FIG. 5, and the method 600 described herein with respect to FIG. 6. Further, the memory 214 may also store data received from various inputs associated with the autonomy system 250, such as perception data from the perception system.

As noted above, perception module 202 may receive input from the various sensors, such as camera system 220, LiDAR system 222, GNSS receiver 208, and/or IMU 224 (collectively “perception data”) to sense an environment surrounding the truck 260 and interpret it. To interpret the surrounding environment, the perception module 202 (or “perception engine”) may identify and classify objects or groups of objects in the environment. For example, the truck 102 may use the perception module 202 to identify one or more objects (e.g., pedestrians, vehicles, debris, etc.) or features of the roadway 114 (e.g., intersections, road signs, lane lines, etc.) before or beside a vehicle and classify the objects in the road. In some embodiments, the perception module 202 may include an image classification function and/or a computer vision function.

The system 100 may collect perception data. The perception data may represent the perceived environment surrounding the vehicle, for example, and may be collected using aspects of the perception system described herein. The perception data can come from, for example, one or more of the LiDAR system, the camera system, and various other externally-facing sensors and systems on board the vehicle (e.g., the GNSS receiver, etc.). For example, on vehicles having a sonar or radar system, the sonar and/or radar systems may collect perception data. As the truck 102 travels along the roadway 114, the system 100 may continually receive data from the various systems on the truck 102. In some embodiments, the system 100 may receive data periodically and/or continuously. With respect to FIG. 1, the truck 102 may collect perception data that indicates presence of the lane lines 116, 118, 120. Features perceived by the vehicle should generally track with one or more features stored in a digital map (e.g., in the mapping/localization module 204). Indeed, with respect to FIG. 1, the lane lines that are detected before the truck 102 is capable of detecting the bend 128 in the road (that is, the lane lines that are detected and correlated with a known, mapped feature) will generally match with features in stored map and the vehicle will continue to operate in a normal fashion (e.g., driving forward in the left lane of the roadway or per other local road rules). However, in the depicted scenario the vehicle approaches a new bend 128 in the road that is not stored in any of the digital maps onboard the truck 102 because the lane lines 116, 118, 120 have shifted right from their original positions 122, 124, 126.

The system 100 may compare the collected perception data with stored data. For example, the system may identify and classify various features detected in the collected perception data from the environment with the features stored in a digital map. For example, the detection systems may detect the lane lines 116, 118, 120 and may compare the detected lane lines with lane lines stored in a digital map. Additionally, the detection systems could detect the road signs 132a, 132b and the landmark 134 to compare such features with features in a digital map. The features may be stored as points (e.g., signs, small landmarks, etc.), lines (e.g., lane lines, road edges, etc.), or polygons (e.g., lakes, large landmarks, etc.) and may have various properties (e.g., style, visible range, refresh rate, etc.), which properties may control how the system 100 interacts with the various features. Based on the comparison of the detected features with the features stored in the digital map(s), the system may generate a confidence level, which may represent a confidence of the vehicle in its location with respect to the features on a digital map and hence, its actual location.

The image classification function may determine the features of an image (e.g., a visual image from the camera system 220 and/or a point cloud from the LiDAR system 222). The image classification function can be any combination of software agents and/or hardware modules able to identify image features and determine attributes of image parameters in order to classify portions, features, or attributes of an image. The image classification function may be embodied by a software module that may be communicatively coupled to a repository of images or image data (e.g., visual data and/or point cloud data) which may be used to determine objects and/or features in real time image data captured by, for example, the camera system 220 and the LiDAR system 222. In some embodiments, the image classification function may be configured to classify features based on information received from only a portion of the multiple available sources. For example, in the case that the captured visual camera data includes images that may be blurred, the system 250 may identify objects based on data from one or more of the other systems (e.g., LiDAR system 222) that does not include the image data.

The computer vision function may be configured to process and analyze images captured by the camera system 220 and/or the LiDAR system 222 or stored on one or more modules of the autonomy system 250 (e.g., in the memory 214), to identify objects and/or features in the environment surrounding the truck 200 (e.g., lane lines). The computer vision function may use, for example, an object recognition algorithm, video tracing, one or more photogrammetric range imaging techniques (e.g., a structure from motion (SfM) algorithms), or other computer vision techniques. The computer vision function may be configured to, for example, perform environmental mapping and/or track object vectors (e.g., speed and direction). In some embodiments, objects or features may be classified into various object classes using the image classification function, for instance, and the computer vision function may track the one or more classified objects to determine aspects of the classified object (e.g., aspects of its motion, size, etc.)

Mapping/localization module 204 receives perception data that can be compared to one or more digital maps stored in the mapping/localization module 204 to determine where the truck 200 is in the world and/or or where the truck 200 is on the digital map(s). In particular, the mapping/localization module 204 may receive perception data from the perception module 202 and/or from the various sensors sensing the environment surrounding the truck 200, and may correlate features of the sensed environment with details (e.g., digital representations of the features of the sensed environment) on the one or more digital maps. The digital map may have various levels of detail and can be, for example, a raster map, a vector map, etc. The digital maps may be stored locally on the truck 200 and/or stored and accessed remotely. In at least one embodiment, the truck 200 deploys with sufficiently stored information in one or more digital map files to complete a mission without connection to an external network during the mission. A centralized mapping system may be accessible via network 260 for updating the digital map(s) of the mapping/localization module 204. The digital map be built through repeated observations of the operating environment using the truck 200 and/or trucks or other vehicles with similar functionality. For instance, the truck 200, a specialized mapping vehicle, a standard autonomous vehicle, or another vehicle, can run a route several times and collect the location of all targeted map features relative to the position of the vehicle conducting the map generation and correlation. These repeated observations can be averaged together in a known way to produce a highly accurate, high-fidelity digital map. This generated digital map can be provided to each vehicle (e.g., from the network 260 to the truck 200) before the vehicle departs on its mission so it can carry it onboard and use it within its mapping/localization module 204. Hence, the truck 200 and other vehicles (e.g., a fleet of trucks similar to the truck 200) can generate, maintain (e.g., update), and use their own generated maps when conducting a mission.

The generated digital map may include an assigned confidence score assigned to all or some of the individual digital feature representing a feature in the real world. The confidence score may be meant to express the level of confidence that the position of the element reflects the real-time position of that element in the current physical environment. Upon map creation, after appropriate verification of the map (e.g., running a similar route multiple times such that a given feature is detected, classified, and localized multiple times), the confidence score of each element will be very high, possibly the highest possible score within permissible bounds.

The vehicle control module 206 may control the behavior and maneuvers of the truck 260. For example, once the systems on the truck 260 have determined its location with respect to map features (e.g., intersections, road signs, lane lines, etc.) the truck 260 may use the vehicle control module 206 and its associated systems to plan and execute maneuvers and/or routes with respect to the features of the environment. The vehicle control module 206 may make decisions about how the truck 260 will move through the environment to get to its goal or destination as it completes its mission. The vehicle control module 206 may consume information from the perception module 202 and the maps/localization module 204 to know where it is relative to the surrounding environment and what other traffic actors are doing.

The vehicle control module 206 may be communicatively and operatively coupled to a plurality of vehicle operating systems and may execute one or more control signals and/or schemes to control operation of the one or more operating systems, for example, the vehicle control module 206 may control one or more of a vehicle steering system, a propulsion system, and/or a braking system. The propulsion system may be configured to provide powered motion for the truck 260 and may include, for example, an engine/motor, an energy source, a transmission, and wheels/tires and may be coupled to and receive a signal from a throttle system, for example, which may be any combination of mechanisms configured to control the operating speed and acceleration of the engine/motor and thus, the speed/acceleration of the truck 260. The steering system may be any combination of mechanisms configured to adjust the heading or direction of the truck 260. The brake system may be, for example, any combination of mechanisms configured to decelerate the truck 260 (e.g., friction braking system, regenerative braking system, etc.) The vehicle control module 206 may be configured to avoid obstacles in the environment surrounding the truck 260 and may be configured to use one or more system inputs to identify, evaluate, and modify a vehicle trajectory. The vehicle control module 206 is depicted as a single module, but can be any combination of software agents and/or hardware modules able to generate vehicle control signals operative to monitor systems and control various vehicle actuators. The vehicle control module 206 may include a steering controller and for vehicle lateral motion control and a propulsion and braking controller for vehicle longitudinal motion.

In disclosed embodiments of a system for planning paths that will minimize the severity of a collision, the system 100, 250 collects perception data on objects that satisfy predetermined criteria for likelihood of collision with the ego vehicle. Such objects are sometimes referred to herein as target objects. Collected perception data on target objects may be used in collision analysis.

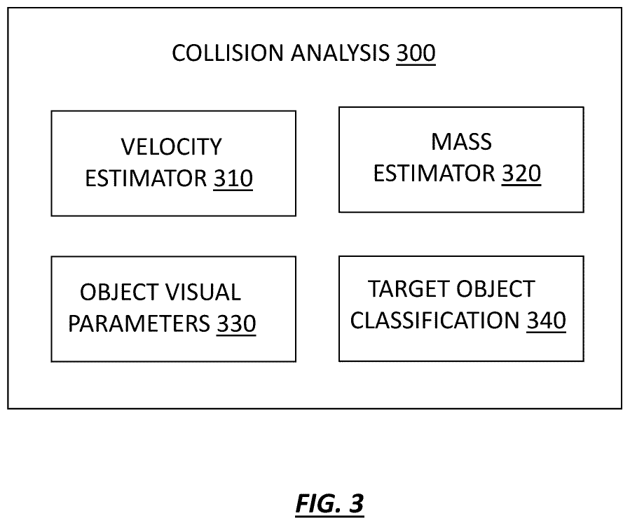

FIG. 3 shows a collision analysis module 300 of system 100, 250. Collision analysis module 300 includes velocity estimator 310, effective mass estimator 320, object visual parameters component 330, target object classification component 340, and cost function analysis module 350. These components of collision analysis module 300 may be either or both software-based components and hardware-based components.

In an embodiment, collision analysis module 230, 300 executes an artificial intelligence model to predict one or more attributes of detected target objects. The artificial intelligence model may be configured to ingest data from at least one sensor of the autonomous vehicle and predict the attributes of the object. In an embodiment, the artificial intelligence module is configured to predict a plurality of predetermined attributes of each of a plurality of detected target objects relative to the autonomous vehicle. The predetermined attributes may include a relative velocity of the respective target object relative to the autonomous vehicle and an effective mass attribute of the respective target object. In an embodiment, the artificial intelligence model is a predictive machine learning model that may be continuously trained using updated data, e.g., relative velocity data, mass attribute data, and target objects classification data. In various embodiments, the artificial intelligence model may employ any class of algorithms that are used to understand relative factors contributing to an outcome, estimate unknown outcomes, discover trends, and/or make other estimations based on a data set of factors collected across prior trials. In an embodiment, the artificial intelligence model may refer to methods such as logistic regression, decision trees, neural networks, linear models, and/or Bayesian models.

Velocity estimator 310 may determine the relative velocity of target objects relative to the ego vehicle. Effective mass estimator 320 may estimate effective mass of target objects, e.g., based on object visual parameters signals from object visual parameters component 330 and object classification signals from target object classification component 340. Object visual parameters component 330 may determine visual parameters of a target object such as size, shape, visual cues and other visual features in response to visual sensor signals, and generates an object visual parameters signal. Target object classification component 340 may determine a classification of a target object using information contained within the object visual parameters signal, which may be correlated to various objects, and generates an object classification signal. For instance, the target object classification component 340 can determine whether the target object is a plastic traffic cone or an animal.

Cost analysis function module 350 may receive inputs from other components of collision analysis module 300 and generates a collision-aware cost function. The system 100, 250 may apply this collision-aware cost function in conjunction with other functions used in path planning. In an embodiment, the cost analysis function module provides a cost map that yields a path that has appropriate margins between the autonomous vehicle and surrounding target objects.

Target objects may include moving objects such as other vehicles, pedestrians, and cyclists in the proximal driving area. Target objects may include fixed objects such as obstacles; infrastructure objects such as rigid poles, guardrails or other traffic barriers; and parked cars. Fixed objects, also herein referred to herein as static objects and non-moving objects can be infrastructure objects as well as temporarily static objects such as parked cars. Systems and methods herein may aim to choose a collision path that may involve a surrounding inanimate object. The systems and methods aim to avoid a vulnerable pedestrian, bicyclist, motorcycle, or other targets involving people or animate beings, and this avoidance is a priority over a collision with an inanimate object.

Externally-facing sensors may provide system 100, 250 with data defining distances between the ego vehicle and target objects in the vicinity of the ego vehicle, and with data defining direction of target objects from the ego vehicle. Such distances can be defined as distances from sensors, or sensors can process the data to generate distances from the center of mass or other portion of the ego vehicle.

In an embodiment, the system 100, 250 collects data on target objects within a predetermined region of interest (ROI) in proximity to the ego vehicle. Objects within the ROI satisfy predetermined criteria for likelihood of collision with the ego vehicle. The ROI is alternatively referred to herein as a region of collision proximity to the ego vehicle. The ROI may be defined with reference to parameters of the vehicle control module 206 in planning and executing maneuvers and/or routes with respect to the features of the environment. In an embodiment, there may be more than one ROI in different states of the system 100, 250 in planning and executing maneuvers and/or routes with respect to the features of the environment, such as a narrower ROI and a broader ROI. For example, the ROI may incorporate data from a lane detection algorithm and may include locations within a lane. The ROI may include locations that may enter the ego vehicle's drive path in the event of crossing lanes, accessing a road junction, swerve maneuvers, or other maneuvers or routes of the ego vehicle. For example, the ROI may include other lanes travelling in the same direction, lanes of opposing traffic, edges of a roadway, road junctions, and other road locations in collision proximity to the ego vehicle.

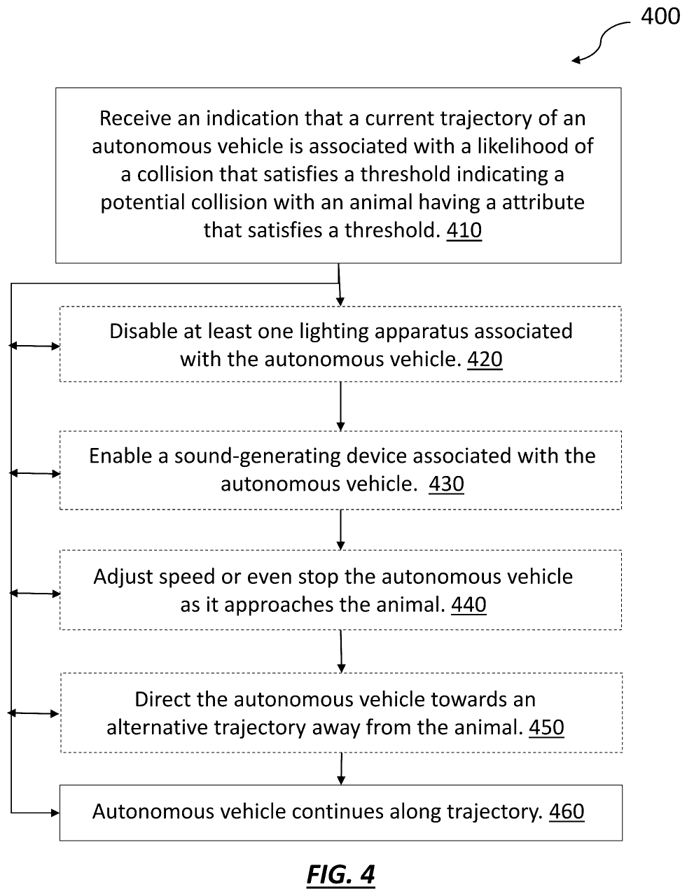

FIG. 4 shows execution steps of a processor-based method using the system 100, 250, and 300 according to some embodiments. The method 400 shown in FIG. 4 comprises execution steps 410-440. However, it should be appreciated that other embodiments may comprise additional or alternative execution steps, or may omit one or more steps altogether. It should also be appreciated that other embodiments may perform certain execution steps in a different order. Steps discussed herein may also be performed simultaneously or near-simultaneously with one another.

FIG. 4 is described as being performed by a processor, such as the processor 210 depicted in FIG. 2. However, in some embodiments, one or more of the steps may be performed by a different processor, server, or any other computing feature. For instance, one or more of the steps may be performed via a cloud-based service or another processor in communication with the processor of the autonomous vehicle and/or its autonomy system.

Although the steps are shown in FIG. 4 having a particular order, it is intended that the steps may be performed in any order. It is also intended that some of these steps may be optional. For example, step 420 may occur after step 430. In another example, step 420 may not be performed when executing this process.

As the process is executed, the processor may determine a likelihood of a collision with a target object (animal). If the likelihood satisfies a threshold, the processor may take another action, such as steps 420, 430, 440, 450. After each step, the processor may evaluate the likelihood again to determine if the threshold is still satisfied, thereby causing another action to urge the animal to move or take evasive action. Once the likelihood no longer satisfies that threshold for a collision, the autonomous vehicle may proceed along the trajectory.

At step 410, the processor may receive an indication that a current trajectory of an autonomous vehicle is associated with a likelihood of a collision that satisfies a threshold indicating a potential collision with an animal having an attribute that satisfies a threshold.

In an embodiment of step 410, the processor detects a target object in proximity to the autonomous vehicle and receives an indication that the current trajectory is associated with a likelihood of a collision that satisfies a threshold indicating a potential collision. In an embodiment of step 410, the processor detects a target object in proximity to the autonomous vehicle, estimates a margin (buffer distance) between the target object and the autonomous vehicle, and receives an indication that the current trajectory is associated with a likelihood of a collision that satisfies a threshold indicating a potential collision.

Via various sensors of the autonomous vehicle, the processor may detect a plurality of target objects in proximity to the autonomous vehicle and receives an indication that the current trajectory is associated with a likelihood of collision with at least one of the plurality of target objects that satisfies a threshold indicating a potential collision.

Via various sensors of the autonomous vehicle, the processor may also detect that the target object is an animal. The processor may use a combination of data received via different sensors, such as cameras, Lidar, and radar, to detect and identify the target objects resemble an animal. In some embodiments, the processor may estimate the mass of the target object (e.g., via the mass estimator 320), identify visual parameters of the object (e.g., whether the target object includes a face or a head via the object visual parameters 330), and/or determine if the object is moving at a speed that is consistent with movement of an animal (e.g., determine that the target object jumped onto the road via the velocity estimator 310). Using the data gathered, the processor may determine that the target object is an animal.

After determining that the target object is an animal, the processor may determine whether the autonomous vehicle has a trajectory/path that interferes with the detected animal. That is, the processor may determine whether a collision likelihood satisfies a threshold. The processor may use various methods discussed herein (e.g., computer vision and/or machine learning algorithms) to analyze the data from the sensors and predict the trajectory of the objects in order to determine if a collision is imminent (within a predetermined time window). If the vehicle determines that a collision is likely, it will take evasive action to avoid the collision. As discussed throughout, the evasive actions may be customized for animals, such that a collision is avoided.

The processor may further compare various attributes of the target object (now identified as an animal) with predetermined thresholds before taking any further actions. As a result, the processor may only proceed with the method 400 when the animal has an attribute (e.g., mass, volume, or density) that satisfies a threshold. Non-limiting examples of predetermined thresholds may include mass thresholds or movement thresholds. For instance, the processor may determine that a target object (determined to be an animal because the processor has identified a face) is within the autonomous vehicle's path and a collision is likely and imminent. However, the target object may not satisfy a mass threshold because the target object is a small fox and because the identified fox does not have a mass that satisfies the mass threshold. As a result, the processor may take no action. In contrast, the processor may determine that an animal detected is a deer, which has a size/mass that satisfies the threshold. As a result, the processor may proceed to the next step.

At step 420, the processor may disable at least one lighting apparatus (e.g., headlamps, fog lamps, parking lights, turn signals) associated with the autonomous vehicle. The processor may first determine which lighting apparatus of the autonomous vehicle is configured to emit light in a direction of the animal. In response, the processor may disable that light, as opposed to all lights associated with the autonomous vehicle. For instance, if the collision with the animal is projected to occur in front of the autonomous vehicle, the processor may only disable the lighting apparatus located in front of the autonomous vehicle (headlights and not taillights). The duration for which the lighting apparatus is turned off may depend on various factors, such as a distance between the animal and the autonomous vehicle and/or a speed of the autonomous vehicle. The processor may optionally only execute the step 420 at night or when a light-sensing sensor of the autonomous vehicle determines that the light exposure is less than a threshold (e.g., indicating that the autonomous vehicle is driving in the dark). In a nighttime situation or in other darkness, the autonomous vehicle may be able to operate based on the sensors and without the lighting apparatus, so disabling the lighting apparatus will not affect the ability of the autonomous vehicle to operate (e.g., sense the road and other conditions for operation). In such a situation, the animal may not be as startled by or fixated on the light, thereby allowing the animal a greater chance to move from the autonomous vehicle's trajectory.

By disabling the lighting apparatus of the autonomous vehicle may still retain various sensors (e.g., infrared sensors, radars, and/or LiDAR) need to continue navigating the autonomous vehicle.

In some embodiments, the autonomous vehicle may include a light filter (e.g., colored filter, such as red filtering) that can be implemented, such that the light emitted from the autonomous vehicle is filtered. In this way, the headlights may not be entirely disabled. Instead, the headlight will emit light that is in a different color.

At step 430, the autonomous vehicle processor may enable a sound-generating device associated with the autonomous vehicle. For instance, the processor may instruct a horn to output a loud noise for a duration of time, such as for a second, two seconds, or five seconds. The sound outputted by the autonomous vehicle may be a predetermined sound (e.g., whistle) that corresponds to the animal detected. For instance, a special predetermined sound may be accessed and emitted instead of the pre-existing horn sound emitted in other occasions. In some embodiments, the duration and intensity of the sound outputted may depend of various factors, such as a distance between the animal and the autonomous vehicle and/or a speed of the autonomous vehicle.

At step 440, the processor may instruct the autonomous vehicle to change its velocity. For instance, the processor may activate a braking mechanism to reduce the speed. The amount of velocity reduction may depend on the current velocity of the autonomous vehicle, the identified animal, distance between the autonomous vehicle and the animal, and the like. The processor may use a variety of predetermined algorithms to determine when, how, and by what amount to reduce the velocity.

At step 450, the processor may direct the autonomous vehicle towards an alternative trajectory away from the detected animal. The processor may identify a plurality of alternative trajectories for the autonomous vehicle. Each alternative trajectory may change the direction of the trajectory for the autonomous vehicle. Non-limiting examples of the alternative trajectory may include changing lanes to avoid the animal or exiting the current route (e.g., existing a highway to avoid a potential collision with the animal).

In some embodiments, the processor may then identify if an alternative trajectory is a viable option (e.g., possible to implement without causing more damage to the autonomous vehicle, other vehicles nearby, and/or other objects nearby) to avoid a collision with the animal. For instance, when the alternative trajectory has a likelihood of collision that satisfies the threshold indicating a potential collision, the autonomous vehicle processor calculates a cost value for the current trajectory and a cost value for the alternative trajectory. The processor may compare the cost values before determining whether an alternative trajectory is justified.

The cost value may be calculated based on the identified animal, distance of the identified animal, current velocity of the autonomous vehicle, surrounding vehicles and their corresponding attributes (e.g., speed of the surrounding vehicles), other objects near the autonomous vehicle, and the like. In an embodiment, the cost value is based on at least one of a mass, volume, density, or material of the objects identified to be near the autonomous vehicle. In some embodiments, the autonomous vehicle processor may execute an artificial intelligence model to predict the attribute of the objects identified to be near the autonomous vehicle. The artificial intelligence model may be configured to ingest data from at least one sensor of the autonomous vehicle and predict the attribute of the object. For instance, the processor may determine that an alternative trajectory may include concrete barriers or plastic cones, which will affect that trajectory's cost value.

The calculated cost value may represent estimated quantified damage to the autonomous vehicle and/or estimated damage (e.g., severity of the damage quantified based on a cost function) to a target object in proximity to the autonomous vehicle for each alternative trajectory (or the original trajectory). That is, the processor may generate a score indicative of possible damage caused if the vehicle continues with the original trajectory and for each alternative trajectory. The processor may use a variety of algorithms to calculate the cost for each trajectory.

After calculating/estimating the cost value for each alternative trajectory, the processor may select a trajectory with the lowest cost value (e.g., indicating the least damage). The processor may then instruct the autonomous vehicle to implement the selected trajectory. For instance, the processor may instruct a vehicle control model where the control module is configured to apply the selected trajectory having the lowest cost value and other system inputs used in path planning to identify, evaluate, and modify the autonomous vehicle's trajectory. The vehicle control module may include a steering controller for vehicle lateral motion control, a propulsion and braking controller for vehicle longitudinal motion, and other vehicle actuators.

The processor may continuously use data received via various sensors to determine whether the likelihood of collision has changed. For instance, when the autonomous vehicle passes the animal, the likelihood of collision may no longer satisfy the collision threshold. This indicates that the autonomous vehicle is no longer at risk of colliding with the animal. As a result, the processor may resume with the original path/trajectory, as shown in step 460. For instance, the processor may enable the lighting apparatus that was previously disabled, disable the sound-generating device previously enabled, and/or increase the velocity to a velocity that corresponds to the original trajectory (e.g., the trajectory before the animal was detected).

FIG. 5 depicts a bird's eye view of a roadway scenario 500, including a schematic representation of an autonomous vehicle 510 and various target objects surrounding the autonomous vehicle 510. The roadway scenario 500 includes a two-lane roadway with traffic flow in two directions (autonomous vehicle 510 and the vehicle 520 as the oncoming traffic). The scenario 500 may also include a bike lane with a cyclist 540.

In the depicted example, the autonomous vehicle 510 contains an autonomy system 512 configured to detect target objects in a region of collision proximity to the autonomous vehicle 510. Target objects include various moving objects, including the vehicle 520 (oncoming traffic) and the cyclist 540 in the bike lane. Target objects may also include static objects, including parked vehicle(s), rigid concrete traffic barrier(s), traffic cones (pylons), and the like. During travel of the autonomous vehicle, the autonomy system 512 senses the surrounding target objects. Specifically, the autonomy system 512 senses a target object 530. Using various methods discussed herein, the autonomy system 512 determines that the target object 530 is an animal that has a size/mass that satisfies a predetermined threshold. The autonomy system 512 then determines an alternative trajectory/path to minimize the severity of a collision (or eliminate the collision altogether) with the target object 530.

The autonomous vehicle 520 may identify three potential trajectories 550, 560, and 570. The first alternative trajectory (trajectory 550) may include steering the autonomous vehicle 510 into the bike lane, and the second alternative trajectory (trajectory 560) may include continuing with the same route with a reduced velocity (and enabling the horn while disabling the headlights), and the third alternative trajectory (trajectory 570) may include steering into oncoming traffic.

The autonomy system 512 may also include a cost for each alternative trajectory. For instance, the alternative trajectory 550 may lead to a probable collision with the cyclist 540 but avoids a collision with the target object 530. As a result, the cost value for the alternative trajectory 550 is high. The alternative trajectory 560 includes the same direction as the original route of the autonomous vehicle 510 before the target object 530 was identified as an animal. The alternative trajectory 560 may include a reduction in speed to avoid possible collision with the target object 530. As a result, the cost value for the alternative path 560 is low because it does not involve any other collisions and it possibly avoids a collision with the target object 530. The alternative trajectory 570 may include a possible collision with oncoming traffic. As a result, the cost value for the alternative path is very high.

The autonomy system 512 may compare the cost values for each alternative trajectory and determine to proceed with the path 560. As a result, the autonomy system 512 reduces the velocity of the autonomous vehicle 510. Additionally, the autonomy system 512 disables headlights (if it is night time), of the autonomous vehicle 510 and causes the horns of the autonomous vehicle 510 to emit a sound (car horn will be activated). Thus, when the autonomous vehicle 510 proceeds along trajectory 560, the autonomous vehicle 510 may disable lights, generate noise (e.g., honk a horn), and/or slow down as the autonomous vehicle 510 approaches the target object 530 or until the target object 530 leaves the roadway.

When the autonomous vehicle passes the target object 530, the autonomy system 512 may resume with the original trajectory. For instance, the autonomous vehicle may increase its speed back to the original speed, turn the headlights back on, and deactivate the horn.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various components, blocks, modules, circuits, and steps have been generally described in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
receiving, by a processor, an indication that a current trajectory of an autonomous vehicle is associated with a likelihood of a collision that satisfies a collision threshold indicating a potential collision with an animal having an attribute that satisfies a threshold;
disabling, by the processor, at least one lighting apparatus associated with the autonomous vehicle; and
enabling, by the processor, a sound-generating device associated with the autonomous vehicle.

2. The method of claim 1, further comprising:
calculating, by the processor, a plurality of alternative trajectories for the autonomous vehicle.

3. The method of claim 2, further comprising:
directing, by the processor, the autonomous vehicle on an alternative trajectory away from the animal based on its cost value.

4. The method of claim 1, wherein the attribute corresponds to a mass, density, or volume of the animal.

5. The method of claim 1, wherein the attribute of the animal is identified by executing an artificial intelligence model configured to ingest data from at least one sensor of the autonomous vehicle and predict the attribute of the animal.

6. The method of claim 1, further comprising:
reducing, by the processor, a velocity of the autonomous vehicle.

7. The method of claim 1, further comprising:
enabling, by the processor, the at least one lighting apparatus when the likelihood of the collision no longer satisfies the collision threshold.

8. The method of claim 1, further comprising:
disabling, by the processor, the sound-generating device when the likelihood of the collision no longer satisfies the collision threshold.

9. A system comprising:
a computer readable medium having a set of instructions, that when executed, cause a processor to:
receive an indication that a current trajectory of an autonomous vehicle is associated with a likelihood of a collision that satisfies a collision threshold indicating a potential collision with an animal having an attribute that satisfies a threshold;
disable at least one lighting apparatus associated with the autonomous vehicle; and
enable a sound-generating device associated with the autonomous vehicle.

10. The system of claim 9, wherein the set of instructions further cause the processor to:
calculate a plurality of alternative trajectories for the autonomous vehicle.

11. The system of claim 10, wherein the set of instructions further cause the processor to:
direct the autonomous vehicle on an alternative trajectory away from the animal based on its cost value.

12. The system of claim 9, wherein the attribute corresponds to a mass, density, or volume of the animal.

13. The system of claim 9, wherein the attribute of the animal is identified by executing an artificial intelligence model configured to ingest data from at least one sensor of the autonomous vehicle and predict the attribute of the animal.

14. The system of claim 9, wherein the set of instructions further cause the processor to:
reduce a velocity of the autonomous vehicle.

15. The system of claim 9, wherein the set of instructions further cause the processor to:
enable the at least one lighting apparatus when the likelihood of the collision no longer satisfies the collision threshold.

16. The system of claim 9, wherein the set of instructions further cause the processor to:
disable the sound-generating device when the likelihood of the collision no longer satisfies the collision threshold.

17. An autonomous vehicle having a processor configured to:
receive an indication that a current trajectory of an autonomous vehicle is associated with a likelihood of a collision that satisfies a collision threshold indicating a potential collision with an animal having an attribute that satisfies a threshold;
disable at least one lighting apparatus associated with the autonomous vehicle; and
enable a sound-generating device associated with the autonomous vehicle.

18. The system of claim 17, wherein the processor is further configured to:
calculate a plurality of alternative trajectories for the autonomous vehicle.

19. The system of claim 17, wherein the processor is further configured to:
direct the autonomous vehicle on an alternative trajectory away from the animal based on its cost value.

20. The system of claim 7, wherein the attribute corresponds to a mass, density, or volume of the animal.
